(19) United States
(12) Patent Application Publication
(10) Pub. No.: US 2026/0204964 A1
(43) Pub. Date: Jul. 16, 2026

(54) POWER TOOL MOTOR ROTOR CONFIGURATIONS

(71) Applicant: MILWAUKEE ELECTRIC TOOL CORPORATION, Brookfield, WI (US)

(72) Inventor: Ashad Farhan, Brookfield, WI (US)

(21) Appl. No.: 19/132,630

(22) PCT Filed: Nov. 30, 2023
(86) PCT No.: PCT/US2023/081901

§ 371 Date: May 23, 2025

Related U.S. Application Data
(60) Provisional application No. 63/385,855, filed on Dec. 2, 2022.
(60) Provisional application No. 63/496,723, filed on Apr. 18, 2023.

(51) Int. Cl. H02K 1/276; H02K 7/14; H02K 9/06; H02K 21/14

(52) U.S. Cl. CPC H02K 1/2773; H02K 7/145; H02K 9/06; H02K 21/14

(57) ABSTRACT

A power tool may include a battery pack interface configured to receive a removable and rechargeable battery pack. A device may include a motor including: a stator including a plurality of stator teeth configured to receive a plurality of stator coils; and a rotor including: a plurality of slots configured in a spoke-type configuration, each of the plurality of slots including a magnet housing portion configured to receive a magnet, a central barrier, a plurality of inner ribs configured to connect the magnet housing portion of the plurality of slots to each other via the central barrier, at least one airspace barrier between the plurality of inner ribs, and wherein the magnet housing portion of the plurality of slots are exposed to the at least one airspace barrier.

### RELATED APPLICATIONS

This application claims the benefit of U.S. Provisional Patent Application No. 63/385,855, filed Dec. 2, 2022, and U.S. Provisional Patent Application No. 63/496,723, filed Apr. 18, 2023.

### FIELD

Embodiments described herein relate to a motor of a power tool.

### SUMMARY

Power tools described herein include a battery pack interface and a motor. The battery pack interface is configured to receive a removable and rechargeable battery pack. The motor includes a stator including a plurality of stator teeth configured to receive a plurality of stator coils, and a rotor including a plurality of slots configured in a spoke-type configuration. Each of the plurality of slots includes a magnet housing portion configured to receive a magnet. The rotor also includes a central barrier, a plurality of inner ribs configured to connect at least one of the magnet housing portions of the plurality of slots to the central barrier. The rotor also includes at least one airspace barrier between the plurality of inner ribs. The at least one magnet housing portion of the plurality of slots is exposed to the at least one airspace barrier.

In some aspects, the magnet includes a length, and the length is larger than half of a width of one of the plurality of stator teeth.

In some aspects, the magnet includes a magnet width, wherein the magnet width is determined based on a diameter of the rotor, a width of a stator tooth, and a number of poles of the motor.

In some aspects, the rotor further includes an outer rib positioned at an outer circumference of the rotor, the outer rib configured to retain a first magnet within a first magnet housing portion.

In some aspects, the rotor further includes a second outer rib positioned at the outer circumference of the rotor, the second outer rib configured to retain a second magnet within a second magnet housing portion.

In some aspects, the outer rib includes a width between approximately 0.1 millimeters and 1.4 millimeters.

In some aspects, the outer rib includes a concave portion formed on the outer circumference of the rotor.

Power tools described herein include a battery pack interface and a motor. The battery pack interface is configured to receive a removable and rechargeable battery pack. The motor includes a stator including a plurality of stator teeth configured to receive a plurality of stator coils and a rotor. The rotor includes a rotor shaft. The rotor shaft portion and a lamination stack portion. A rotor includes a plurality of slots configured in a spoke-type configuration. Each of the plurality of slots includes a magnet housing portion configured to receive a magnet. The rotor includes a plurality of outer rib portions positioned on an outer circumference of the magnet housing portion. Each of the plurality of outer rib portions includes a first length extending a first distance in an axial direction of the rotor. The rotor includes a plurality of inner shoe portions positioned on the magnet housing portion. Each of the plurality of inner shoe portions includes a convex portion and a concave portion. An overmolding includes a material injected between the lamination stack portion and the rotor shaft portion.

In some aspects, the magnet includes a length, and the length is larger than half of a width of one of the plurality of stator teeth.

In some aspects, the magnet includes a magnet width, wherein the magnet width is determined based on a diameter of the rotor, a width of a stator tooth, and a number of poles of the motor.

In some aspects, each of the plurality of outer rib portions includes a width in a range of approximately 0.1 millimeters to 1.4 millimeters.

In some aspects, each of the plurality of inner shoe portions includes a first length and a first width.

In some aspects, the plurality of inner shoe portions is configured to retain the magnet within the magnet housing portions.

In some aspects, the material injected between the lamination stack portion and the rotor shaft portion is one selected from a group consisting of an injection molding plastic, epoxy resin, Polyurethane, silicon steel, a composite material, and a thermal interface material.

Power tools described herein include a battery pack interface and a motor. The battery pack interface is configured to receive a removable and rechargeable battery pack. The motor includes a stator including a plurality of stator teeth configured to receive a plurality of stator coils and a rotor. The rotor includes a lamination stack and a plurality of slots configured in a spoke-type configuration. Each of the plurality of slots includes a magnet housing portion configured to receive a magnet. The rotor includes a shaft including a knurled portion extending a first circumferential distance around the shaft and a smooth portion extending a second circumferential distance around the shaft. The rotor includes a crumple zone positioned on an inner portion of rotor. The crumple zone is configured to deform an inner rib of the rotor.

In some aspects, the magnet includes a length, the length being larger than half of a width of one of the plurality of stator teeth.

In some aspects, the magnet includes a magnet width, wherein the magnet width is determined based on a diameter of the rotor, a width of a stator tooth, and a number of poles of the motor.

In some aspects, the rotor further includes a minimum interference fit between an outer circumference of the shaft and an inner circumference of the lamination stack, the minimum interference fit being less than or equal to 10 microns.

In some aspects, the crumple zone is further configured to deform the inner rib during press fitting.

In some aspects, the rotor further includes a first key groove positioned on a first portion of the lamination stack and a second key groove positioned on a second portion of the shaft, the first key groove and the second key groove configured to prevent slipping of the lamination stack.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### BRIEF DESCRIPTION OF THE DRAWINGS

FIG. 1 illustrates a side view of a power tool in accordance with some embodiments.

FIG. 2 illustrates a block diagram of a control system of the power tool of FIG. 1 in accordance with some embodiments.

FIG. 3 illustrates a battery pack for use with the power tool of FIG. 1 in accordance with some embodiments.

FIG. 4 illustrates a block diagram of a control system of the battery pack of FIG. 3 in accordance with some embodiments.

FIG. 5 illustrates a rotor including a spoke-type magnet configuration according to some embodiments.

FIG. 6 illustrates a rotor including a spoke-type magnet configuration according to some embodiments.

FIG. 7 illustrates a rotor including a spoke-type magnet configuration according to some embodiments.

FIG. 8 illustrates a rotor including a spoke-type magnet configuration according to some embodiments.

FIG. 9 illustrates a rotor including a spoke-type magnet configuration according to some embodiments.

FIG. 10 illustrates a rotor including a spoke-type magnet configuration according to some embodiments.

FIG. 11A-11B illustrates a rotor including a spoke-type magnet configuration according to some embodiments.

FIG. 12 illustrates a rotor including a spoke-type magnet configuration according to some embodiments.

FIGS. 13A and 13B illustrate a rotor including a spoke-type magnet configuration according to some embodiments.

FIG. 14A-14B illustrate a rotor including a spoke-type magnet configuration according to some embodiments.

FIG. 15 illustrates an expanded view of a motor rotor including a spoke-type magnet configuration according to some embodiments.

### DETAILED DESCRIPTION

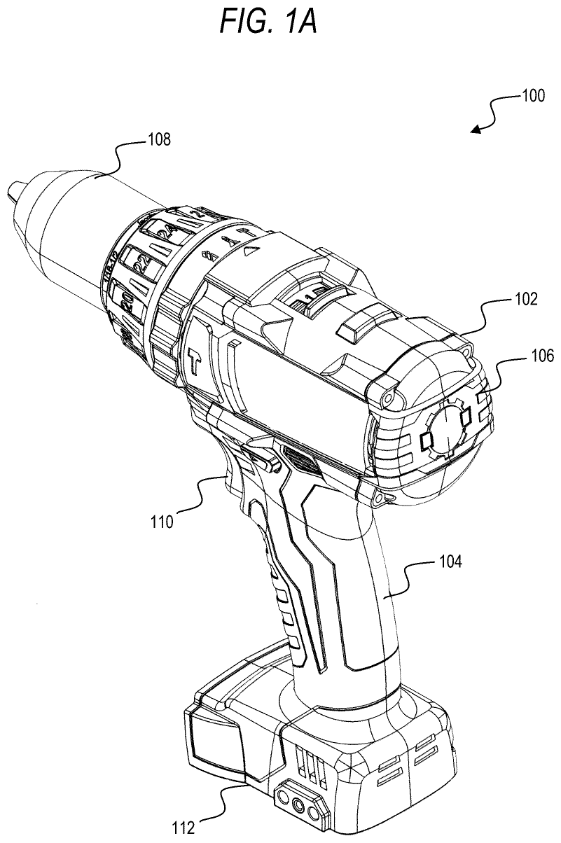

FIG. 1 illustrates a power tool 100 including a permanent magnet motor. The power tool 100 is, for example, a hammer drill including a housing 102. The housing 102 includes a handle portion 104 and motor housing portion 106. The power tool 100 further includes an output driver 108 (illustrated as a chuck), a trigger 110, and a battery pack interface 112. The battery pack interface 112 is configured to mechanically and electrically connect to or receive a removable, rechargeable power tool battery pack (also referred to as a battery pack). Although FIG. 1 illustrates a hammer drill, in some embodiments, the components described herein are incorporated into other types of power tools including drill-drivers, impact drivers, impact wrenches, angle grinders, circular saws, reciprocating saws, plate compactors, core drills, string trimmers, leaf blowers, vacuums, and the like. In a permanent magnet motor power tool, such as power tool 100, switching elements are selectively enabled and disabled by control signals from a controller to selectively apply power from a power source (e.g., battery pack) to drive a permanent magnet motor.

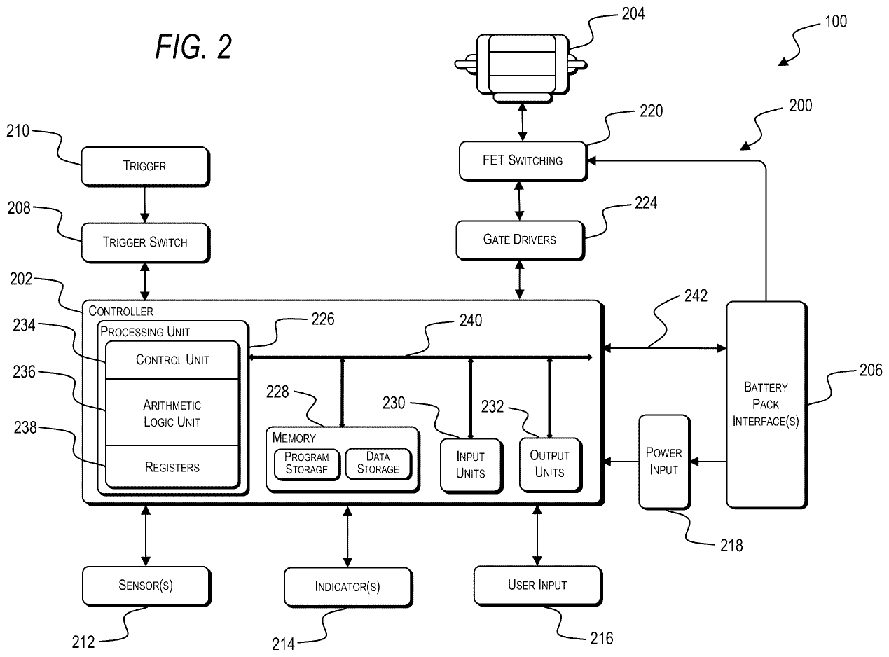

FIG. 2 illustrates a control system 200 for the power tool 100. The control system 200 includes a controller 202. The controller 202 is electrically and/or communicatively connected to a variety of modules or components of the power tool 100. For example, the illustrated controller 202 is electrically connected to a motor 204, a battery pack interface 206, a trigger switch 208 (connected to a trigger 210), one or more sensors 212 or sensing circuits, one or more indicators 214, a user input module 216, a power input module 218, an inverter bridge or FET switching module 220 (e.g., including a plurality of switching FETs), and gate drivers 224 for driving the FET switching module 220. In some embodiments, motor 204 is a permanent magnet motor. The controller 202 includes combinations of hardware and software that are operable to, among other things, control the operation of the power tool 100, monitor the operation of the power tool 100, activate the one or more indicators 214 (e.g., an LED), etc.

The controller 202 includes a plurality of electrical and electronic components that provide power, operational control, and protection to the components and modules within the controller 202 and/or the power tool 100. For example, the controller 202 includes, among other things, a processing unit 226 (e.g., a microprocessor, a microcontroller, an electronic controller, an electronic processor, or another suitable programmable device), a memory 228, input units 230, and output units 232. The processing unit 226 includes, among other things, a control unit 234, an arithmetic logic unit (“ALU”) 236, and a plurality of registers 238, and is implemented using a known computer architecture (e.g., a modified Harvard architecture, a von Neumann architecture, etc.). The processing unit 226, the memory 228, the input units 230, and the output units 232, as well as the various modules or circuits connected to the controller 202 are connected by one or more control and/or data buses (e.g., common bus 240). The control and/or data buses are shown generally in FIG. 2 for illustrative purposes. The use of one or more control and/or data buses for the interconnection between and communication among the various modules, circuits, and components would be known to a person skilled in the art in view of the invention described herein.

The memory 228 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 226 is connected to the memory 228 and executes software instructions that are capable of being stored in a RAM of the memory 228 (e.g., during execution), a ROM of the memory 228 (e.g., on a generally permanent basis), or another non-transitory computer readable medium such as another memory or a disc. Software included in the implementation of the power tool 100 can be stored in the memory 228 of the controller 202. The software includes, for example, firmware, one or more applications, program data, filters, rules, one or more program modules, and other executable instructions. The controller 202 is configured to retrieve from the memory 228 and execute, among other things, instructions related to the control processes and methods described herein. In other constructions, the controller 202 includes additional, fewer, or different components.

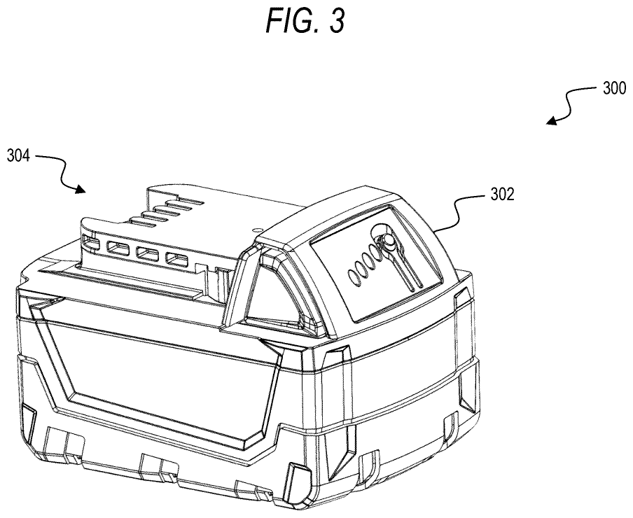

The battery pack interface 206 includes a combination of mechanical components (e.g., rails, grooves, latches, etc.) and electrical components (e.g., one or more terminals) configured to and operable for interfacing (e.g., mechanically, electrically, and communicatively connecting) with a battery pack. For example, power provided by a battery pack 300 (see FIG. 3) to the power tool 100 is provided through the battery pack interface 206 to the power input module 218. The power input module 218 includes combinations of active and passive components to regulate or control the power received from the battery pack 300 prior to power being provided to the controller 202. The battery pack interface 206 also supplies power to the FET switching module 220 to be switched by the switching FETs to selectively provide power to the motor 204. The battery pack interface 206 also includes, for example, a communication line 242 for providing a communication line or link between the controller 202 and the battery pack 300.

The sensors 212 include one or more current sensors, one or more speed sensors, one or more Hall effect sensors, one or more temperature sensors, etc. The indicators 214 include, for example, one or more light-emitting diodes (“LEDs”). The indicators 214 can be configured to display conditions of, or information associated with, the power tool 100. For example, the indicators 214 are configured to indicate measured electrical characteristics of the power tool 100, the status of the power tool, the status the motor 204, etc. The user input module 216 is operably coupled to the controller 202 to, for example, select a forward mode of operation or a reverse mode of operation, a torque and/or speed setting for the power tool 100 (e.g., using torque and/or speed switches), etc. In some embodiments, the user input module 216 includes a combination of digital and analog input or output devices required to achieve a desired level of operation for the power tool 100, such as one or more knobs, one or more dials, one or more switches, one or more buttons, etc.

FIG. 3 illustrates a battery pack 300. The battery pack 300 includes a housing 302 and an interface portion 304 for connecting the battery pack 300 to a power tool, such as the power tool 100.

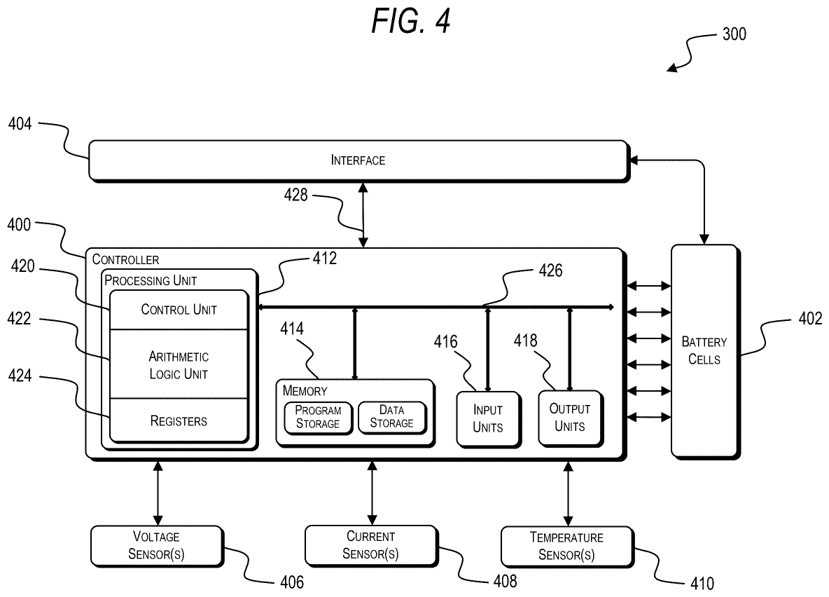

FIG. 4 illustrates a control system for the battery pack 300. The control system includes a controller 400. The controller 400 is electrically and/or communicatively connected to a variety of modules or components of the battery pack 300. For example, the illustrated controller 400 is connected to one or more battery cells 402 and an interface 404 (e.g., the interface portion 304 of the battery pack 300 illustrated in FIG. 3). The controller 400 is also connected to one or more voltage sensors or voltage sensing circuits 406, one or more current sensors or current sensing circuits 408, and one or more temperature sensors or temperature sensing circuits 410. The controller 400 includes combinations of hardware and software that are operable to, among other things, control the operation of the battery pack 300, monitor a condition of the battery pack 300, enable or disable charging of the battery pack 300, enable or disable discharging of the battery pack 300, etc.

The controller 400 includes a plurality of electrical and electronic components that provide power, operational control, and protection to the components and modules within the controller 400 and/or the battery pack 300. For example, the controller 400 includes, among other things, a processing unit 412 (e.g., a microprocessor, a microcontroller, an electronic processor, an electronic controller, or another suitable programmable device), a memory 414, input units 416, and output units 418. The processing unit 412 includes, among other things, a control unit 420, an ALU 422, and a plurality of registers 424, and is implemented using a known computer architecture (e.g., a modified Harvard architecture, a von Neumann architecture, etc.). The processing unit 412, the memory 414, the input units 416, and the output units 418, as well as the various modules or circuits connected to the controller 400 are connected by one or more control and/or data buses (e.g., common bus 426). The control and/or data buses are shown generally in FIG. 4 for illustrative purposes. The use of one or more control and/or data buses for the interconnection between and communication among the various modules, circuits, and components would be known to a person skilled in the art in view of the invention described herein.

The memory 414 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 412 is connected to the memory 414 and executes software instructions that are capable of being stored in a RAM of the memory 414 (e.g., during execution), a ROM of the memory 414 (e.g., on a generally permanent basis), or another non-transitory computer readable medium such as another memory or a disc. Software included in the implementation of the battery pack 300 can be stored in the memory 414 of the controller 400. The software includes, for example, firmware, one or more applications, program data, filters, rules, one or more program modules, and other executable instructions. The controller 400 is configured to retrieve from the memory 414 and execute, among other things, instructions related to the control processes and methods described herein. In other constructions, the controller 400 includes additional, fewer, or different components.

The interface 404 includes a combination of mechanical components (e.g., rails, grooves, latches, etc.) and electrical components (e.g., one or more terminals) configured to and operable for interfacing (e.g., mechanically, electrically, and communicatively connecting) the battery pack 300 with another device (e.g., a power tool, a battery pack charger, etc.). For example, the interface 404 is configured to communicatively connect to the controller 400 via a communications line 428.

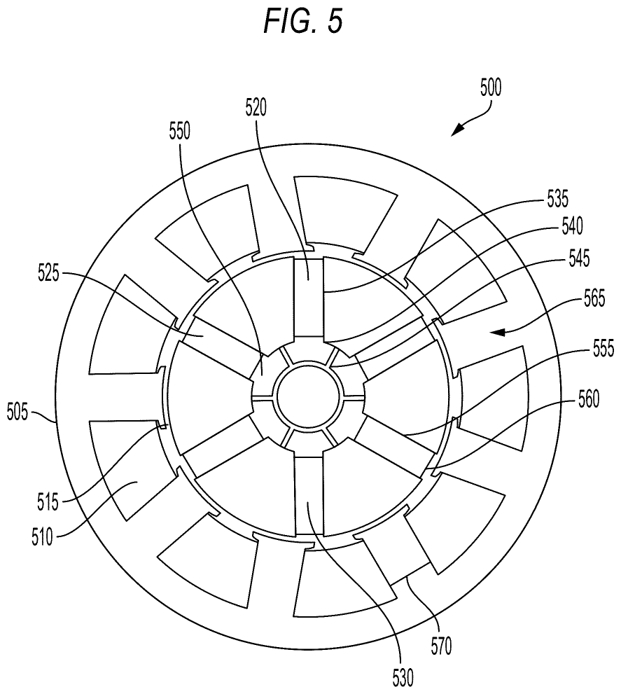

FIG. 5 illustrates a motor 500 for use in the power tool 100. The motor 500 includes a spoke-type magnet configuration. The motor 500 includes a stator 505 and a plurality of stator winding slots 510. The plurality of stator winding slots 510 are configured to receive a plurality of windings (also referred to as stator coils). The motor 500 also includes a rotor 515. The rotor 515 includes a plurality of slots 520 configured in a spoke-type configuration, and each of the plurality of slots 520 includes a magnet housing portion 525 configured to receive a magnet 530. The magnet may be made of neodymium, ferrite, or another type of magnetic material. In some examples, the magnet 530 may be fixed within the magnet housing portion 525 using injection molding, adhesives, or another method of securely seating the magnets. The magnet housing portion 525 includes a first portion 535 spaced a first radial distance from the center of rotation of the rotor, and a second portion 540 spaced a second radial distance from the center of rotation of the rotor. In the illustrated embodiment, the second portion 540 includes inner ribs 545 configured to connect the magnet housing portions to each other via a central barrier. Between the inner ribs 545 is an air gap 550. The magnet housing portions 525 are configured to receive the magnets 530. The magnets 530 including a length 555 and a width 560.

In some examples, the length 555 of the magnet 530 is larger than half of a width 565 of a stator tooth 570 (also referred to as stator teeth). In some examples, the width 560 of the magnet 530 is determined based upon the following equation:

$$Magnet Width = \frac{π ( diameter of rotor - stator tooth width )}{number of poles} \qquad EQN . 1$$

For example, a motor may include a rotor diameter of 40 millimeters, a stator tooth width of 8 millimeters, and have 6 poles. In this example, the maximum width of the magnet is approximately 16.7 millimeters.

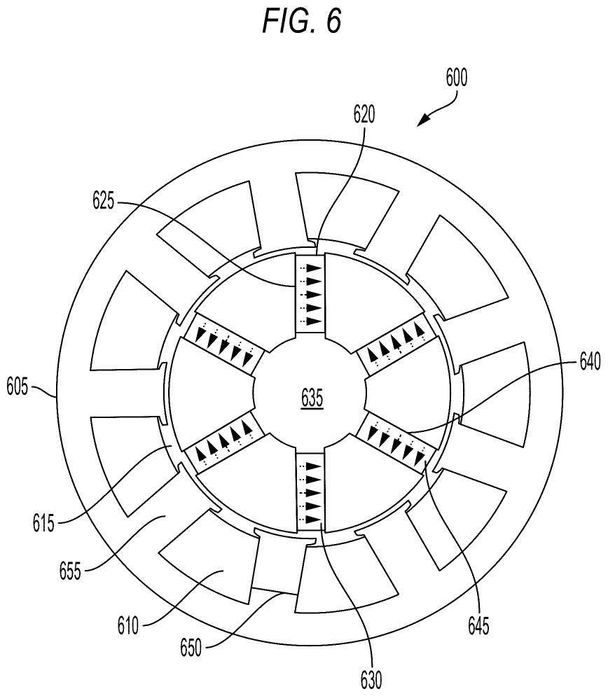

FIG. 6 illustrates a motor 600 for use in the power tool 100. The motor 600 includes a spoke-type magnet configuration. The motor 600 includes a stator 605 and a plurality of stator winding slots 610. The plurality of stator winding slots 610 are configured to receive a plurality of windings. The motor 600 also includes a rotor 615. The rotor 615 includes a plurality of slots 620 configured in a spoke-type configuration, and each of the plurality of slots 620 includes a magnet housing portion 625 configured to receive a magnet 630. The magnet 630 may be composed of similar materials as previously described, and/or secured to the magnet housing portion 625 as previously described. In the illustrated embodiment, the rotor 615 includes an open central rotor 635 that would receive a motor shaft. The open central rotor 635 advantageously improves the overall electromagnetic performance of the motor 600 by approximately 5%. The magnet housing portions are configured to receive the magnets 630, the magnets including a length 640 and a width 645. In some examples, the length 640 of the magnet 630 must be larger than half of a width 650 of a stator tooth 655. In some examples, the width 645 of the magnet 630 may be determined by EQN. 1 as described above.

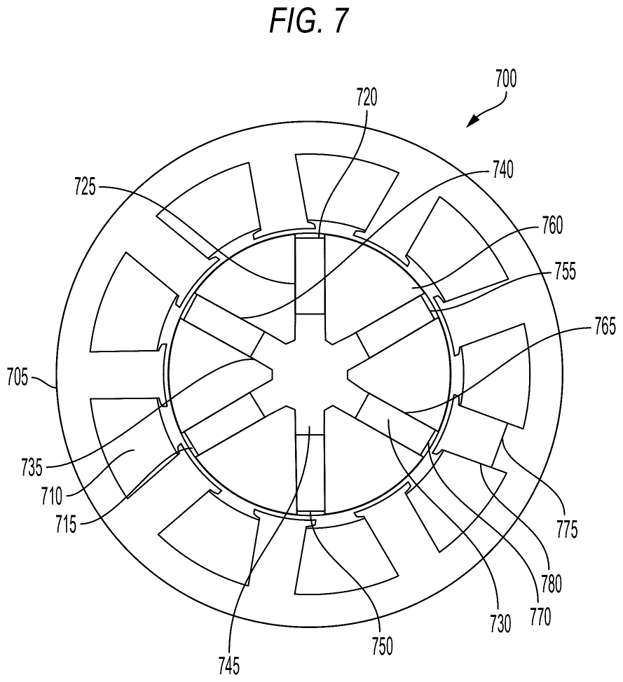

FIG. 7 illustrates a motor 700 for use in the power tool 100. The motor 700 includes a spoke-type magnet configuration. The motor 700 includes a stator 705 and a plurality of stator winding slots 710. The plurality of stator winding slots 710 are configured to receive a plurality of windings. The motor 700 also includes a rotor 715. The rotor 715 includes a plurality of slots 720 configured in a spoke-type configuration, and each slot includes a magnet housing portion 725 configured to receive a magnet 730. The magnet 730 may be composed of similar materials as previously described, and/or secured to the magnet housing portion 725 as previously described. The magnet housing portion includes a first portion 735 spaced a first radial distance from the center of rotation of the rotor 715, and a second portion 740 spaced a second radial distance from the center of rotation of the rotor 715. In the illustrated embodiment, the second portion 740 includes an open central rotor 745 and an outer rib 750 for each magnet housing portion 725. The outer rib 750 is positioned to close the plurality of slots 720. The outer rib includes a length 755 and a width 760. For example, the width 760 of the outer rib may be between 0.1 millimeters and 1.4 millimeters. The magnet housing portions are configured to receive the magnets, the magnets including a length 765 and a width 770. In some examples, the length 765 of the magnet 730 must be larger than half of a width 775 of a stator tooth 780. In some examples, the width 775 of the magnet 730 may be determined by EQN. 1 as described above.

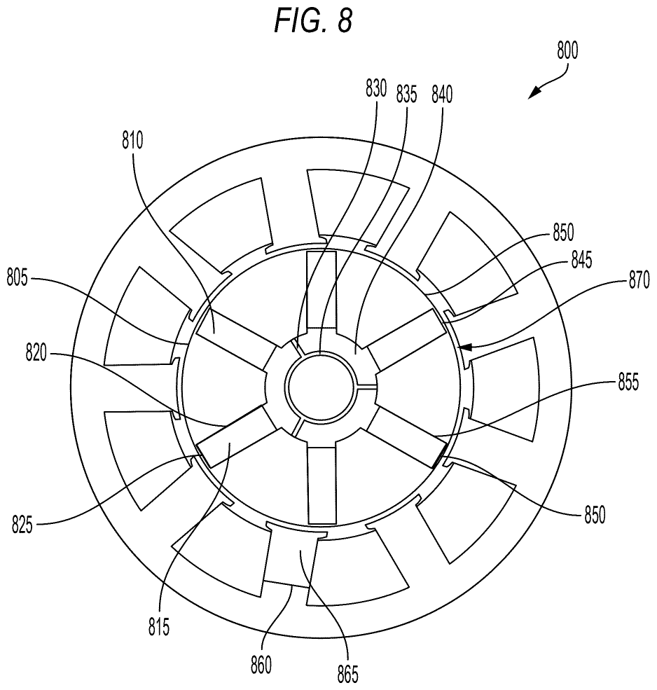

FIG. 8 illustrates a motor 800 including rotor 805 for use in the power tool 100. The rotor 805 includes a spoke-type magnet configuration. The rotor 805 includes a plurality of slots configured in a spoke-type configuration, and each slot includes a magnet housing portion 810. The magnet housing portions 810 are each configured to receive a magnet 815. The magnet 815 may be composed of similar materials as previously described, and/or secured to the magnet housing portion 810 as previously described. The magnet 815 include a length 820 and a width 825. In some examples, the length 820 of the magnet 815 must be larger than half of a width 860 of a stator tooth 865. In some examples, the width 825 of the magnet 815 may be determined by EQN. 1 as described above.

In the illustrated embodiment, the rotor 805 includes inner ribs 830 configured to connect the magnet housing portions 810 to each other via a central barrier 835 (e.g., a central ring or arcuate portion of the rotor 805). The inner ribs 830 are alternatively spaced between every other of the plurality of slots. Positioned between the inner ribs 830 is a flux barrier, or airspace barrier 840. In some instances, there are a plurality of inner ribs and a plurality of airspace barriers, and at least one of the plurality of air space barriers is between a corresponding one of the plurality of inner ribs. The magnet housing portions 810 are exposed to the airspace barrier 840 on an inner portion of the rotor 805, and the magnet housing portions 810 include an outer rib 845 positioned at an outer portion 850 of the rotor 805. The outer rib 845 includes a length 855 and a width 860. For example, the width of the outer rib 845 may be between 0.1 millimeters and 1.4 millimeters. In some embodiments, the outer ribs 845 each include a concave portion 870 formed on an outer circumference of the rotor 805.

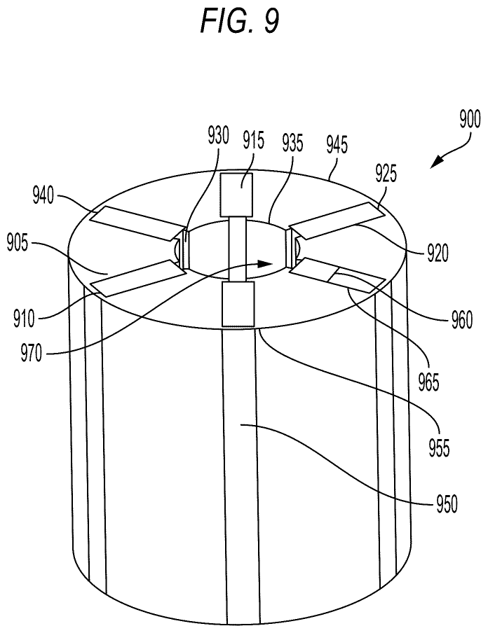

FIG. 9 illustrates a motor rotor 900 including a spoke-type magnet configuration. The rotor 900 includes a plurality of slots 905 configured in a spoke-type configuration, and each slot 905 includes a magnet housing portion 910 configured to receive a magnet 915. The magnet 915 may be composed of similar materials as previously described, and/or secured to the magnet housing portion 910 as previously described. The magnets 915 include a length 920 and a width 925. In some examples, the length 920 of the magnet 915 must be larger than half of a width 960 of a stator tooth 965. In some examples, the width 925 of the magnet 915 may be determined by EQN. 1 as described above.

In some embodiments, the magnet housing portions 910 include a magnet holding portions 930, also referred to as a shoe, positioned on an inner circumference 935 of the magnet housing portions 910. The shoe is configured to assist the magnet housing portion 910 in securely housing the magnet 915. In some instances, the shoe thickness is greater than 0.2 mm, and the space between the each of the shoes is greater than 0.2 mm. Additionally, in some embodiments, the magnet housing portion 910 includes an outer rib 940. The outer rib 940 is positioned on an outer circumference 945 of the magnet housing portion 910. The outer rib 940 includes a length 950 and a width 955. For example, the width of the outer rib 940 may be between 0.1 millimeters and 1.4 millimeters. In some embodiments, the rotor 900 includes an open central rotor 970, similar to the open central rotor 635 as previously described and illustrated in FIG. 6.

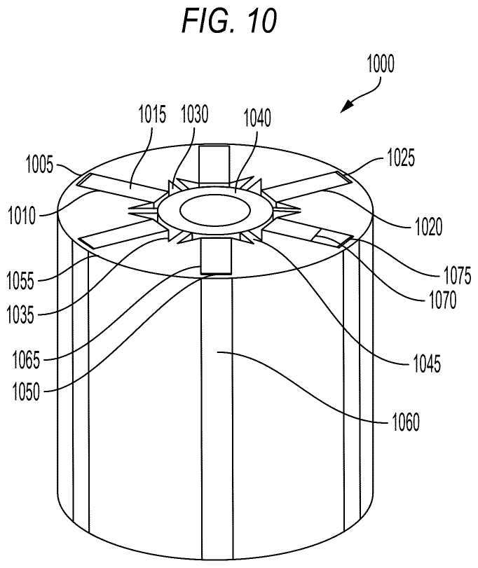

FIG. 10 illustrates a rotor 1000 for use with the power tool 100. The rotor 1000 includes a spoke-type magnet configuration. The rotor 1000 includes a plurality of slots 1005 configured in a spoke-type configuration, and each slot 1005 includes a magnet housing portion 1010 configured to receive a magnet 1015. The magnet 1015 may be composed of similar materials as previously described, and/or secured to the magnet housing portion 1010 as previously described. The magnets 1015 include a length 1020 and a width 1025. In some examples, the length 1020 of the magnet 1015 must be larger than half of a width 1070 of a stator tooth 1075. In some examples, the width 1025 of the magnet 1015 may be determined by the equation as described above. In some embodiments, the magnet housing portion 1010 includes an air gap 1030 positioned on an inner circumference 1035 of the magnet housing portion 1010. The air gap 1030 separates the magnet housing portion from a central circumference 1040 of the rotor 1000. The air gaps 1030 includes inner ribs 1045 positioned between two of the magnet housing portions 1010. Additionally, in some embodiments, the magnet housing portion 1010 includes an outer rib 1050. The outer rib 1050 is positioned on an outer circumference 1055 of the magnet housing portion 1010. The outer rib 1050 includes a length 1060 and a width 1065. For example, the width of the outer rib 1050 may be between 0.1 millimeters and 1.4 millimeters. In some examples, the width 1025 of the magnet 1015 may be determined by EQN. 1 as described above.

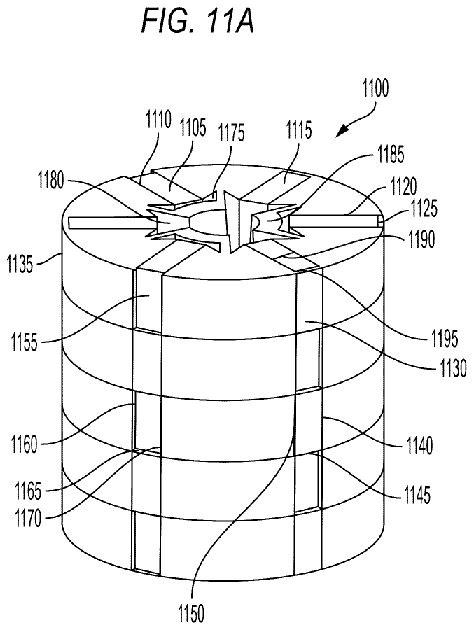

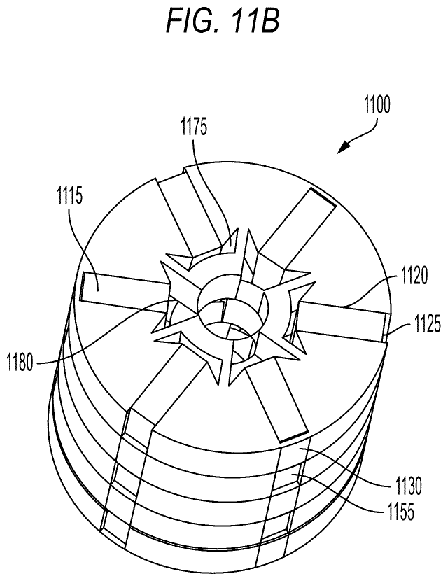

FIGS. 11A and 11B illustrate a rotor 1100 for use with the power tool 100. In some instances, the rotor 1100 as configured in FIGS. 11A and 11B has a reduced flux leakage as compared to alternative motor configurations, such as the rotor 1000 previously illustrated in and described with respect to FIG. 10. The rotor 1100 includes a spoke-type magnet configuration. The rotor 1100 includes a plurality of slots 1105 configured in a spoke-type configuration, and each slot includes a magnet housing portion 1110 configured to receive a magnet 1115. The magnet 1115 may be composed of similar materials as previously described, and/or secured to the magnet housing portion 1110 as previously described. The magnets 1115 include a length 1120 and a width 1125. In some examples, the length 1120 of the magnet 1115 must be larger than half of a width 1190 of a stator tooth 1195. In some examples, the width 1125 of the magnet 1115 may be determined by the equation as described above. In some embodiments, the rotor 1100 includes a plurality of alternating outer rib portions 1130 positioned on an outer circumference 1135 of the magnet housing portion 1110. The plurality of alternating outer rib portions 1130 includes a length 1140 and a width 1145. In some instances, the width 1145 of the outer rib portions 1130 spans a range of between 0.1 millimeters and 1.4 millimeters. The length extends a first longitudinal distance 1150 in an axial direction of the rotor 1100. Additionally, the magnet housing portions 1110 include a plurality of outer air gaps 1155 spaced between each of the plurality of alternating outer rib portions 1130, such that the space between each of the plurality of alternating outer rib portions 1130 includes a length 1160 and a width 1165, the length 1160 extending a second longitudinal distance 1170 in the axial direction of the rotor 1100. In some examples, the outer air gaps 1155 include a length and a width approximately equal to the length 1160 and width 1165 of each of the plurality of alternating outer rib portions 1130. In some examples, the width 1125 of the magnet 1115 may be determined by EQN. 1 as described above.

In some embodiments, the magnet housing portion includes a plurality of inner air gap portions 1175 positioned on an inner circumference 1180 of the magnet housing portion 1110. The plurality of inner air gap portions 1175 separates the magnet housing portion 1110 from a central circumference 1185 of the rotor 1100. In some embodiments, the plurality of inner air gap portions 1175 are spaced in an opposite configuration to the plurality of outer rib portions 1130. For example, for the first longitudinal distance 1150, the magnet housing portion 1110 includes an outer rib portion 1130 but does not include an inner air gap portion 1175, and for the second longitudinal distance 1170, the magnet housing portion 1110 includes an inner air gap portion 1175, but does not include an outer rib portion 1130.

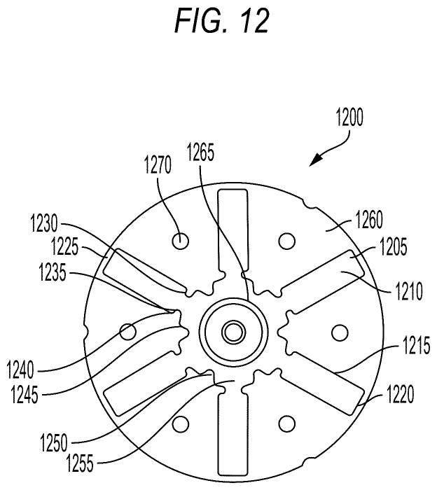

FIG. 12 illustrates a rotor 1200 for use in the power tool 100. The rotor 1200 includes a spoke-type magnet configuration. The rotor 1200 includes a plurality of slots 1205 configured in a spoke-type configuration, and each slot 1205 includes a magnet housing portion 1210 configured to receive a magnet. The magnet may be composed of similar materials as previously described, and/or secured to the magnet housing portion 1210 as previously described. The magnet housing portion 1210 includes a length 1215 and a width 1220. In some embodiments, the magnet housing portions 1210 include an outer rib portion 1225, as similarly previously described, and the outer rib portion may span a range of between 0.1 millimeters and 1.4 millimeters. The magnet housing portions 1210 also include an inner shoe portion 1230 configured to securely retain the magnet. The inner shoe portion 1230 includes a first length 1235 and a first width 1240 on each side of the inner shoe portion 1230. In some embodiments, the inner shoe portion 1230 includes a convex portion 1245 and a concave portion 1250. In some embodiments, the magnet housing portion 1210 includes a plurality of inner shoe portions. For example, in some instances, the magnet housing portion 1210 includes two inner shoe portions, where each of the inner shoe portions are configured on opposite sides of the magnet housing portion, and where each of the two inner shoe portions are configured to retain the magnet within the magnet housing portion 1210.

In some embodiments, the rotor 1200 includes an overmolding shaft 1255 on an inside circumference of the rotor 1200. The overmolding may be, for example, a material injected between a lamination stack portion 1260 of the rotor 1200 and a shaft portion 1265 of the rotor 1200. For instance, the material may be one selected from a group consisting of injection molding plastic, an epoxy resin, Polyurethane, silicon steel, a composite material, a thermal interface material, or the like. The lamination stack portion 1260 includes gaps 1270 formed between adjacent magnet housing portions 1210. In some embodiments, gaps 1270 are also filled with injected material. In some examples, the width 1220 of a magnet for the magnet housing portions 1210 may be determined by EQN. 1 as described above.

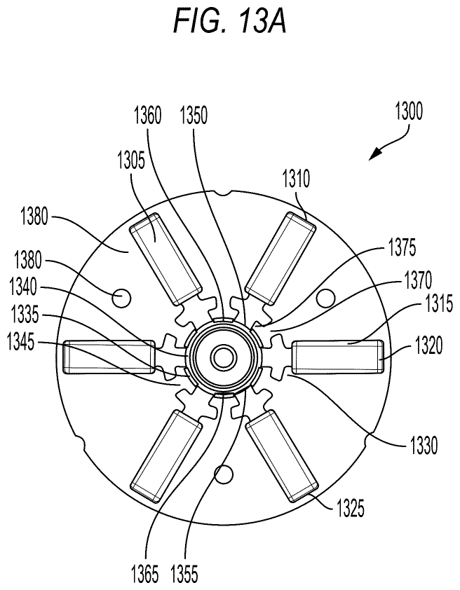

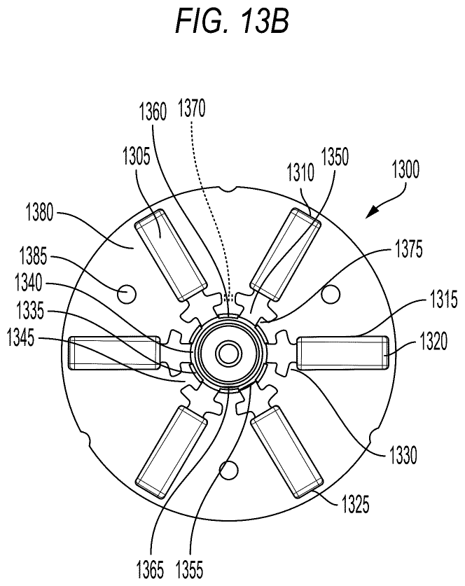

FIGS. 13A and 13B illustrate a rotor 1300 for use in the power tool 100. The rotor 1300 includes a spoke-type magnet configuration. The rotor 1300 includes a plurality of slots 1305 configured in a spoke-type configuration, and each slot 1305 includes a magnet housing portion 1310 configured to receive a magnet. The magnet may be composed of similar materials as previously described, and/or secured to the magnet housing portion 1310 as previously described. The magnet housing portion 1310 includes a length 1315 and a width 1320. In some embodiments, the magnet housing portions 1310 include an outer rib portion 1325 and an inner shoe 1330, and an inner rib 1375 as similarly previously described. In some examples, the rotor 1300 includes a minimum interference fit 1335 between an outer circumference 1340 of the shaft and an inner circumference 1345 of the lamination stack. For example, in some embodiments, the minimum interference fit 1335 may be no larger than 10 microns. In some embodiments, the surface of the shaft includes a knurled portion 1350 that extends a first circumferential distance 1355 around the shaft and a smooth portion 1360 that extends a second circumferential distance 1365 around the shaft. In some examples, the rotor 1300 includes a crumple zone 1370 positioned on an inner portion of rotor 1300, as shown in FIG. 13B. In some instances, the crumple zone may be configured to compress, or deform, the inner rib 1375 during press fitting of the shaft. A lamination stack portion 1380 includes gaps 1385. In some examples, the width 1320 of a magnet for the magnet housing portions 1310 may be determined by EQN. 1 as described above.

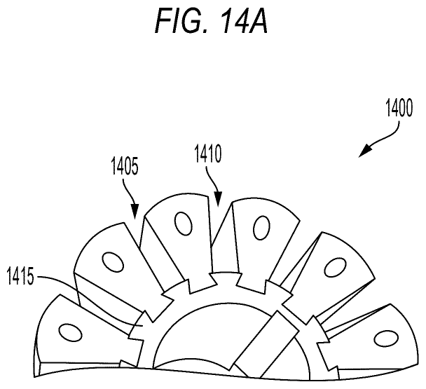

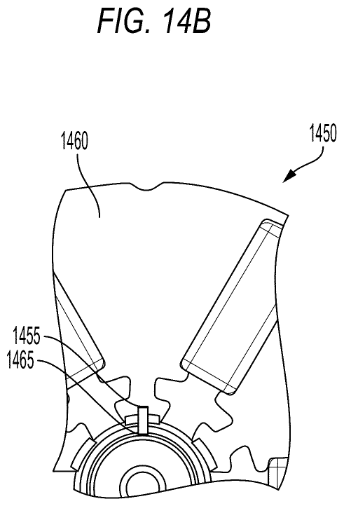

FIG. 14A illustrates a rotor 1400 for use with the power tool 100. The rotor 1400 includes a spoke-type magnet configuration. The rotor 1400 includes a plurality of slots 1405 configured in a spoke-type configuration, and each slot 1405 includes a magnet housing portion 1410 configured to receive a magnet. The magnet may be composed of similar materials as previously described, and/or secured to the magnet housing portion 1410 as previously described. The plurality of slots 1405 and the magnet housing portions 1410 are similar to previously described slots and magnet housing portions. In some embodiments, the rotor includes a stainless-steel ring portion 1415 on an interior of the rotor 1400. In some examples, a width of a magnet for the magnet housing portions 1410 may be determined by EQN. 1 as described above.

FIG. 14B illustrates a rotor 1450 for use with the power tool 100. The rotor 1450 includes a first key groove 1455 positioned on a portion of a lamination stack 1460 of the rotor 1450, and a second key groove 1465 positioned on a portion of the shaft. In some embodiments, the first key groove 1455 and the second key groove 1465 reduce, eliminate, or prevent slipping of the lamination stack 1460.

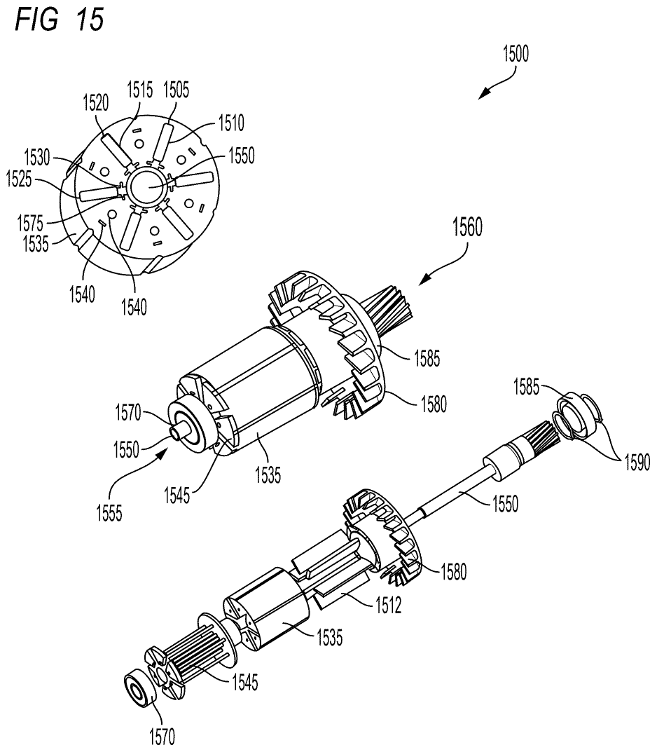

FIG. 15 illustrates a rotor 1500 for use with the power tool 100. The rotor 1500 includes a plurality of slots 1505 configured in a spoke-type configuration, and each slot 1505 includes a magnet housing portion 1510 configured to receive a magnet 1512. The magnet 1512 may be composed of similar materials as previously described, and/or secured to the magnet housing portion 1510 as previously described. The magnet housing portion 1510 includes a length 1515 and a width 1520. In some embodiments, the magnet housing portions 1510 include an outer rib portion 1525, an inner shoe 1530, and an inner rib 1575, as similarly previously described. The rotor includes a lamination stack 1535 including a plurality of gaps 1540. In some instances, the gaps 1540 are filled with an injection molded material, such as injection molded plastic 1545. The rotor 1500 also includes a shaft 1550 extending through the rotor 1500 from a first end 1555 of the rotor 1500 to a second end 1560 of the rotor 1500. Located at the first end 1555 of the rotor 1500 is a first bearing 1570. The rotor 1500 also includes a fan 1580 located at the second end of the rotor 1500. The rotor further includes a second bearing 1585 located at the second end 1560 of the rotor, and a plurality of C-rings 1590 configured to couple the second bearing 1585 to the rotor 1500 shaft 1550. In some embodiments, the shaft 1550 is includes a knurled surface for injection molding purposes.

### Representative Features

Representative features are set out in the following clauses, which stand alone or may be combined, in any combination, with one or more features disclosed in the text and/or drawings of the specification.
1. A power tool comprising:
   a battery pack interface configured to receive a removable and rechargeable battery pack; and
   a motor including:
      a stator including a plurality of stator teeth configured to receive a plurality of stator coils, and
      a rotor including:
         a plurality of slots configured in a spoke-type configuration, each of the plurality of slots including a magnet housing portion configured to receive a magnet,
         a central barrier,
         a plurality of inner ribs configured to connect at least one of the magnet housing portions of the plurality of slots to the central barrier,
         at least one airspace barrier between the plurality of inner ribs,
   wherein the at least one of the magnet housing portions of the plurality of slots is exposed to the at least one airspace barrier.
2. The power tool of clause 1, wherein the magnet includes a length, the length being larger than half of a width of one of the plurality of stator teeth.
3. The power tool of any preceding clause, wherein the magnet includes a magnet width, wherein the magnet width is determined based on a diameter of the rotor, a width of a stator tooth, and a number of poles of the motor.
4. The power tool of any preceding clause, wherein the rotor further includes an outer rib positioned at an outer circumference of the rotor, the outer rib configured to retain a first magnet within a first magnet housing portion.
5. The power tool of clause 4, wherein the rotor further includes a second outer rib positioned at the outer circumference of the rotor, the second outer rib configured to retain a second magnet within a second magnet housing portion.
6. The power tool of clause 4, wherein the outer rib includes a width between approximately 0.1 millimeters and 1.4 millimeters.
7. The power tool of clause 4, wherein the outer rib includes a concave portion formed on the outer circumference of the rotor.
8. A power tool comprising:
   a battery pack interface configured to receive a removable and rechargeable battery pack; and
   a motor including:
      a stator including a plurality of stator teeth configured to receive a plurality of stator coils, and
      a rotor including:
         a rotor shaft portion,
         a lamination stack portion,
         a plurality of slots configured in a spoke-type configuration, each of the plurality of slots including a magnet housing portion configured to receive a magnet,
         a plurality of outer rib portions positioned on an outer circumference of the magnet housing portions, wherein each of the plurality of outer rib portions includes a first length extending a first distance in an axial direction of the rotor,
         a plurality of inner shoe portions positioned on the magnet housing portions, each of the plurality of inner shoe portions includes a convex portion and a concave portion, and
         an overmolding including a material injected between the lamination stack portion and the rotor shaft portion.
9. The power tool of clause 8, wherein the magnet includes a length, the length being larger than half of a width of one of the plurality of stator teeth.
10. The power tool of any of clauses 8 or 9, wherein the magnet includes a magnet width, wherein the magnet width is determined based on a diameter of the rotor, a width of a stator tooth, and a number of poles of the motor.
11. The power tool of any of clauses 8 to 10, wherein each of the plurality of outer rib portions includes a width in a range of approximately 0.1 millimeters to 1.4 millimeters.
12. The power tool of any of clauses 8 to 11, wherein each of the plurality of inner shoe portions includes a first length and a first width.
13. The power tool of any of clauses 8 to 12, wherein the plurality of inner shoe portions is configured to retain the magnet within the magnet housing portions.
14. The power tool of clause 13, wherein the material injected between the lamination stack portion and the rotor shaft portion is one selected from a group consisting of an injection molding plastic, epoxy resin, Polyurethane, silicon steel, a composite material, and a thermal interface material.
15. A power tool comprising:
   a battery pack interface configured to receive a removable and rechargeable battery pack; and
   a motor including:
      a stator including a plurality of stator teeth configured to receive a plurality of stator coils, and
      a rotor including:
         a lamination stack,
         a plurality of slots configured in a spoke-type configuration, each of the plurality of slots including a magnet housing portion configured to receive a magnet,
         a shaft including a knurled portion extending a first circumferential distance around the shaft and a smooth portion extending a second circumferential distance around the shaft, and
         a crumple zone positioned on an inner portion of rotor, the crumple zone configured to deform an inner rib of the rotor.
16. The power tool of clause 15, wherein the magnet includes a length, the length being larger than half of a width of one of the plurality of stator teeth.
17. The power tool of any of clauses 15 or 16, wherein the magnet includes a magnet width, wherein the magnet width is determined based on a diameter of the rotor, a width of a stator tooth, and a number of poles of the motor.
18. The power tool of any of clauses 15 to 17, wherein the rotor further includes a minimum interference fit between an outer circumference of the shaft and an inner circumference of the lamination stack, the minimum interference fit being less than or equal to 10 microns.
19. The power tool of any of clauses 15 to 18, wherein the crumple zone is further configured to deform the inner rib during press fitting.
20. The power tool of any of clauses 15 to 19, wherein the rotor further includes a first key groove positioned on a first portion of the lamination stack and a second key groove positioned on a second portion of the shaft, the first key groove and the second key groove configured to prevent slipping of the lamination stack.

Thus, embodiments described herein provide a power tool including a spoke-type motor. Various features and advantages are set forth in the following claims.

What is claimed is:

1. A power tool comprising:
a battery pack interface configured to receive a removable and rechargeable battery pack; and
a motor including:
a stator including a plurality of stator teeth configured to receive a plurality of stator coils, and
a rotor including:
a plurality of slots configured in a spoke-type configuration, each of the plurality of slots including a magnet housing portion configured to receive a magnet,
a central barrier,
a plurality of inner ribs configured to connect at least one of the magnet housing portions of the plurality of slots to the central barrier,
at least one airspace barrier between the plurality of inner ribs,
wherein the at least one of the magnet housing portions of the plurality of slots is exposed to the at least one airspace barrier.

2. The power tool of claim 1, wherein the magnet includes a length, the length being larger than half of a width of one of the plurality of stator teeth.

3. The power tool of claim 1, wherein the magnet includes a magnet width, wherein the magnet width is determined based on a diameter of the rotor, a width of a stator tooth, and a number of poles of the motor.

4. The power tool of claim 1, wherein the rotor further includes an outer rib positioned at an outer circumference of the rotor, the outer rib configured to retain a first magnet within a first magnet housing portion.

5. The power tool of claim 4, wherein the rotor further includes a second outer rib positioned at the outer circumference of the rotor, the second outer rib configured to retain a second magnet within a second magnet housing portion.

6. The power tool of claim 4, wherein the outer rib includes a width between approximately 0.1 millimeters and 1.4 millimeters.

7. The power tool of claim 4, wherein the outer rib includes a concave portion formed on the outer circumference of the rotor.

8. A power tool comprising:
a battery pack interface configured to receive a removable and rechargeable battery pack; and
a motor including:
a stator including a plurality of stator teeth configured to receive a plurality of stator coils, and
a rotor including:
a rotor shaft portion,
a lamination stack portion,
a plurality of slots configured in a spoke-type configuration, each of the plurality of slots including a magnet housing portion configured to receive a magnet,
a plurality of outer rib portions positioned on an outer circumference of the magnet housing portions, wherein each of the plurality of outer rib portions includes a first length extending a first distance in an axial direction of the rotor,
a plurality of inner shoe portions positioned on the magnet housing portions, each of the plurality of inner shoe portions includes a convex portion and a concave portion, and
an overmolding including a material injected between the lamination stack portion and the rotor shaft portion.

9. The power tool of claim 8, wherein the magnet includes a length, the length being larger than half of a width of one of the plurality of stator teeth.

10. The power tool of claim 8, wherein the magnet includes a magnet width, wherein the magnet width is determined based on a diameter of the rotor, a width of a stator tooth, and a number of poles of the motor.

11. The power tool of claim 8, wherein each of the plurality of outer rib portions includes a width in a range of approximately 0.1 millimeters to 1.4 millimeters.

12. The power tool of claim 8, wherein each of the plurality of inner shoe portions includes a first length and a first width.

13. The power tool of claim 8, wherein the plurality of inner shoe portions is configured to retain the magnet within the magnet housing portions.

14. The power tool of claim 13, wherein the material injected between the lamination stack portion and the rotor shaft portion is one selected from a group consisting of an injection molding plastic, epoxy resin, Polyurethane, silicon steel, a composite material, and a thermal interface material.

15. A power tool comprising:
a battery pack interface configured to receive a removable and rechargeable battery pack; and
a motor including:
a stator including a plurality of stator teeth configured to receive a plurality of stator coils, and
a rotor including:
a lamination stack,
a plurality of slots configured in a spoke-type configuration, each of the plurality of slots including a magnet housing portion configured to receive a magnet,
a shaft including a knurled portion extending a first circumferential distance around the shaft and a smooth portion extending a second circumferential distance around the shaft, and
a crumple zone positioned on an inner portion of rotor, the crumple zone configured to deform an inner rib of the rotor.

16. The power tool of claim 15, wherein the magnet includes a length, the length being larger than half of a width of one of the plurality of stator teeth.

17. The power tool of claim 15, wherein the magnet includes a magnet width, wherein the magnet width is determined based on a diameter of the rotor, a width of a stator tooth, and a number of poles of the motor.

18. The power tool of claim 15, wherein the rotor further includes a minimum interference fit between an outer circumference of the shaft and an inner circumference of the lamination stack, the minimum interference fit being less than or equal to 10 microns.

19. The power tool of claim 15, wherein the crumple zone is further configured to deform the inner rib during press fitting.

20. The power tool of claim 15, wherein the rotor further includes a first key groove positioned on a first portion of the lamination stack and a second key groove positioned on a second portion of the shaft, the first key groove and the second key groove configured to prevent slipping of the lamination stack.
